(19) United States
(12) Patent Application Publication
(10) Pub. No.: US 2014/0339466 A1
(43) Pub. Date: Nov. 20, 2014

(54) Cathode Active Material For Lithium Ion Battery, Cathode For Lithium Ion Battery, And Lithium Ion Battery

(71) Applicant: JX Nippon Mining & Metals Corporation, Chiyoda-ku, Tokyo (JP)

(72) Inventor: Kentaro Okamoto, Kitaibaraki-shi (JP)

(21) Appl. No.: 14/364,830

(22) PCT Filed: May 29, 2013
(86) PCT No.: PCT/JP2013/064941

§ 371 Date: Jun. 12, 2014

(30) Foreign Application Priority Data
Sep. 19, 2012 (JP) 2012-206133

(51) Int. Cl. H01M 4/485; H01M 4/505; H01M 4/525

(52) U.S. Cl. CPC H01M 4/485; H01M 4/525; H01M 4/505; H01M 2220/20
USPC 252/182.1

(57) ABSTRACT

There is provided a cathode active material for a lithium ion battery having good battery properties. The cathode active material for a lithium ion battery is a cathode active material for a lithium ion battery represented by a composition formula: LiₓNi_{1-y}M_{y}O_{2+α} wherein 0.9≦x≦1.2; 0<y≦0.7; and −0.1≦α≦0.1; and M is a metal(s), wherein a maximum value of the generation rate in a peak originated from H₂O in the region is 200 to 400° C. of 5 ppm by weight/sec or lower in a measurement by TPD-MS of 5 to 30 mg of the cathode active material.

### TECHNICAL FIELD

The present invention relates to a cathode active material for a lithium ion battery, a cathode for a lithium ion battery, and a lithium ion battery.

### BACKGROUND ART

For cathode active material for lithium ion batteries, lithium-containing transition metal oxides are usually used. The lithium-containing transition metal oxides are specifically lithium cobaltate (LiCoO₂), lithium nickelate (LiNiO₂), lithium manganate (LiMn₂O₄), and the like, and making these into a composite has been progress in order to improve properties (capacity enhancement, cycle properties, preservation properties, internal resistance reduction, and rate characteristic) and enhance safety. For lithium ion batteries in large-size applications as for vehicles and road leveling, properties different from those for cellular phones and personal computers hitherto are demanded.

For the improvement of the battery properties, various methods have conventionally been used, and for example, Patent Literature 1 discloses a lithium ion secondary battery characterized by using as its negative electrode a composite carbonaceous material obtained by firing a mixture of a graphite material and an organic material in a mixed gas atmosphere containing 50 ppm or more and 8,000 ppm or less of an oxidizing gas (oxygen, ozone, F₂, SO₃, NO₂, N₂O₄, air, steam, or the like) in an inert gas, and crushing the fired material. The Patent Literature states that there can be provided a lithium secondary battery using a carbon material as its negative electrode, and being improved in the decrease of the charge and discharge capacity at a high current density which would be seen in conventional materials and maintaining a high capacity even at the quick charge and discharge. The use of a lithium nickel composite oxide as a cathode active material described in Patent Literature 1 improves the properties of a lithium ion battery using the cathode active material by controlling the concentration of an oxidizing gas in a firing atmosphere in a firing step of a precursor of the cathode active material.

### CITATION LIST

### Patent Literature

[Patent Literature 1] Japanese Patent Laid-Open No. 11-273676

### SUMMARY OF INVENTION

### Technical Problem

Although the amount of lithium to be fed is usually made large in order to promote the oxidation of a cathode active material precursor in the firing time, left-over lithium due to the excess amount thereof fed is liable to become a remaining alkali. The moisture contained in a cathode active material extracts lithium of the cathode active material, which results in making remaining alkalis of lithium hydroxide and lithium carbonate much. Since remaining alkalis on the surface of a cathode active material, the moisture contained in the cathode and hydroxyl groups generated as a result of a reaction with extracted water react with an electrolyte solution when a battery is fabricated, the amount of the electrolyte solution necessary for the battery becomes in a deficient state, then leading to the deterioration of the battery properties.

The moisture in a cathode active material and the remaining alkalis thus adversely affect the battery properties, and are conventionally removed by various means. However, there is still room for improvement as a high-quality cathode active material for a lithium ion battery.

Then, an object of the present invention is to provide a cathode active material for a lithium ion battery having good battery properties.

### Solution to Problem

As a result of exhaustive studies, the present inventor has found that close correlations exists between the maximum values of generation rates in a peak originated from H₂O and/or a peak originated from CO₂ gas in a predetermined temperature region as acquired by a TPD-MS measurement and the battery properties. That is, it has been found that when the maximum values of the generation rates in a peak originated from H₂O and/or a peak originated from CO₂ gas in a predetermined temperature region as acquired by a TPD-MS measurement are controlled at certain values or lower, good battery properties can be obtained.

An aspect of the present invention completed based on the above-mentioned finding is a cathode active material for a lithium ion battery represented by a composition formula:

LiₓNi_{1-y}M_{y}O_{2+α}

wherein 0.9≦x≦1.2; 0<y≦0.7; and −0.1≦α≦0.1; and M is a metal(s),

wherein a maximum value of the generation rate in a peak originated from H₂O in the region of 200 to 400° C. is 5 ppm by weight/sec or lower in a measurement by TPD-MS of 5 to 30 mg of the cathode active material.

Another aspect of the present invention is a cathode active material for a lithium ion battery represented by a composition formula:

LiₓNi_{1-y}M_{y}O_{2+α}

wherein 0.9≦x≦1.2; 0<y≦0.7; and −0.1≦α≦0.1; and M is a metal(s),

wherein a maximum value of the generation rate in a peak originated from CO₂ gas in the region of 150 to 400° C. is 3 ppm by weight/sec or lower in a measurement by TPD-MS of 5 to 30 mg of the cathode active material.

A further another aspect of the present invention is a cathode active material for a lithium ion battery represented by a composition formula:

LiₓNi_{1-y}M_{y}O_{2+α}

wherein 0.9≦x≦1.2; 0<y≦0.7; and −0.1≦α≦0.1; and M is a metal(s),

wherein a maximum value of the generation rate in a peak originated from H₂O in the region of 200 to 400° C. is 5 ppm by weight/sec or lower and a maximum value of the generation rate in a peak originated from CO₂ gas in the region of 150 to 400° C. is 3 ppm by weight/sec or lower in the measurement by TPD-MS of 5 to 30 mg of the cathode active material.

In an embodiment of the cathode active material for a lithium ion battery according to the present invention, the maximum value of the generation rate in a peak originated from H₂O in the region of 200 to 400° C. is 3 ppm by weight/sec or lower in the measurement by TPD-MS of 5 to 30 mg of the cathode active material.

In another embodiment of the cathode active material for a lithium ion battery according to the present invention, the maximum value of the generation rate in a peak originated from CO₂ gas in the region of 150 to 400° C. is 2 ppm by weight/sec or lower in the measurement by TPD-MS of 5 to 30 mg of the cathode active material.

In a further another embodiment of the cathode active material for a lithium ion battery according to the present invention, the M is one or more selected from Ti, V, Cr, Mn, Co, Fe, Mg, Cu, Zn, Al, Sn, and Zr.

In a further another embodiment of the cathode active material for a lithium ion battery according to the present invention, the M is one or more selected from Mn and Co.

Further another aspect of the present invention is a cathode for a lithium ion battery using the cathode active material for a lithium ion battery according to the present invention.

Further another aspect of the present invention is a lithium ion battery using the cathode for a lithium ion battery according to the present invention.

### Advantageous Effect of Invention

The present invention can provide a cathode active material for a lithium ion battery having good battery properties.

### BRIEF DESCRIPTION OF DRAWING

FIG. 1 shows generation rate curves of H₂O, CO₂, and O₂ acquired by a TPD-MS measurement in Example 7.

### DESCRIPTION OF EMBODIMENTS

### (Constitution of a Cathode Active Material for a Lithium Ion Battery)

As a material for the cathode active material for a lithium ion battery according to the present invention, compounds useful as cathode active material for usual cathode for lithium ion batteries can broadly be used, but particularly lithium-containing transition metal oxides such as lithium cobaltate (LiCoO₂), lithium nickelate (LiNiO₂), and lithium manganate (LiMn₂O₄) are preferably used. A cathode active material for a lithium ion battery according to the present invention produced using such a material is represented by a composition formula:

LiₓNi_{1-y}M_{y}O_{2+α}

wherein 0.9≦x≦1.2; 0<y≦0.7; and −0.1≦α≦0.1; and M is a metal(s).

The ratio of lithium to the whole metal in the cathode active material for a lithium ion battery is 0.9 to 1.2; and this is because with the ratio of lower than 0.9, a stable crystal structure can hardly be held, and with the ratio exceeding 1.2, a high capacity of the battery cannot be secured.

In the cathode active material for a lithium ion battery, the M is preferably one or more selected from Ti, V, Cr, Mn, Co, Fe, Mg, Cu, Zn, Al, Sn, and Zr, and more preferably one or more selected from Mn and Co. If the M is such a metal, the substitution with a metal(s) such as Mn is easy, and an advantage of having the thermal stability as metals is provided.

In the cathode active material for a lithium ion battery according to the present invention the maximum value of the generation rate in a peak originated from H₂O in the region of 200 to 400° C. is 5 ppm by weight/sec or lower in a measurement by TPD-MS of 5 to 30 mg of the cathode active material.

Further, in the cathode active material for a lithium ion battery according to the present invention exhibits the maximum value of the generation rate in a peak originated from CO₂ gas in the region of 150 to 400° C. is 3 ppm by weight/sec or lower in a measurement by TPD-MS of 5 to 30 mg of the cathode active material.

Further, in the cathode active material for a lithium ion battery according to the present invention exhibits the maximum value of the generation rate in a peak originated from H₂O in the region of 200 to 400° C. is 5 ppm by weight/sec or lower and the maximum value of the generation rate in a peak originated from CO₂ gas in the region of 150 to 400° C. is 3 ppm by weight/sec or lower in the measurement by TPD-MS of 5 to 30 mg of the cathode active material.

Temperature Programmed Desorption-Mass Spectrometry (TPD-MS: thermally generated gas analysis) is constituted such that a mass spectrometer (MS) is directly connected with a special heating apparatus with a temperature controller. In TPD-MS, the concentration changes of gases generated from a sample heated according to a predetermined temperature-rising program are traced as functions of temperature or time. Since the analysis is carried out on-line, the simultaneous detection of inorganic components such as moisture and organic components can be made in a measurement of one time. The qualitative determination of organic components can also be made by GC/MS analysis of the collected trapped materials.

The measurement of the amount of moisture is conventionally usually carried out by a technique using a Karl Fischer moisture meter. The amount of remaining alkali is often measured by putting a cathode active material in water and causing the remaining alkalis to be extracted. However, both the measuring methods have drawbacks. The Karl Fischer moisture meter measures a sample by raising the temperature, but the measurement can be made only up to 300° C. due to the meter characteristic. However, actual moisture cannot be removed in the temperature region in many cases. Particularly the moisture, for example, entrapped and reacted inside the particles of a cathode active material can hardly be removed, and is left remaining in many cases. The extraction method not only dissolves out lithium as a remaining alkali of the particle surface but also may possibly dissolve out lithium in the layer by extraction using water. Therefore, in order to improve the battery properties, it becomes important that the amount of moisture contained in a cathode active material and the amount of remaining alkali are accurately measured and controlled in fabrication of a battery. Conventionally, the moisture and the remaining alkali to be essentially measured cannot fully be measured as described above, and a cathode active material suppressed in such materials cannot be obtained.

By contrast, TPD-MS can measure the moisture and the amount of generated gas at important temperatures exceeding 300° C. and to 400° C., and can control the moisture and the amount of remaining alkali (that is, amount of generated CO₂ gas) generated at the temperatures by using the measurement values.

In the measurement by TPD-MS of 5 to 30 mg of a cathode active material, if the maximum value of the generation rate in a peak originated from H₂O in the region of 200 to 400° C. is 5 ppm by weight/sec or lower, or if the maximum value of the generation rate in a peak originated from CO₂ gas in the region of 150 to 400° C. is 3 ppm by weight/sec or lower, the battery properties of a lithium ion battery using the cathode active material becomes better.

If the maximum value of the generation rate in a peak originated from H₂O in the region of 200 to 400° C. is 5 ppm by weight/sec or lower and the maximum value of the generation rate in a peak originated from CO₂ gas in the region of 150 to 400° C. is 3 ppm by weight/sec or lower in the measurement by TPD-MS of 5 to 30 mg of the cathode active material, the battery properties of a lithium ion battery using the cathode active material become better.

In the measurement by TPD-MS of 5 to 30 mg of a cathode active material, the maximum value of the generation rate in a peak originated from H₂O in the region of 200 to 400° C. is preferably 3 ppm by weight/sec or lower, and more preferably 1 ppm by weight/sec or lower.

In the measurement by TPD-MS of 5 to 30 mg of a cathode active material, the maximum value of the generation rate in a peak originated from CO₂ gas in the region of 150 to 400° C. is preferably 2 ppm by weight/sec or lower, and more preferably 1 ppm by weight/sec or lower.

(Constitutions of a Aathode for a Lithium Ion Battery and a Lithium Ion Battery using the Cathode)

A cathode for a lithium ion battery according to an embodiment of the present invention has a structure in which a cathode mixture prepared by mixing, for example, the cathode active material for a lithium ion battery having the above-mentioned constitution, an conduction promoting agent, and a binder is provided on one surface or both surfaces of a current collector composed of an aluminum foil or the like. Further a lithium ion battery according to an embodiment of the present invention has a cathode for a lithium ion battery having such a constitution.

### (Method for Producing a Cathode Active Material for a Lithium Ion Battery)

Then, a method for producing a cathode active material for a lithium ion battery according to an embodiment of the present invention will be described in detail.

First, a metal salt solution is prepared. The metals are Ni, and one or more selected from Ti, V, Cr, Mn, Co, Fe, Mg, Cu, Zn, Al, Sn, and Zr. The metal salts are sulfate salts, chlorides, nitrate salts, acetate salts, or the like, and are especially preferably nitrate salts. This is because even if there occurs mingling thereof as impurities in a firing raw material, since the nitrate salts can be fired as they are, a washing step can be omitted, and because the nitrate salts function as an oxidizing agent and have a function of promoting the oxidization of the metals in the firing raw material. Each metal contained in the metal salts is adjusted so as to be in a desired molar ratio. The molar ratio of the each metal in a cathode active material is thereby determined.

Then, lithium carbonate is suspended in pure water; and the metal salt solution of the above metals is charged therein to thereby prepare a metal carbonate salt solution slurry. At this time, microparticulate lithium-containing carbonate salts are deposited in the slurry. In the case where lithium compounds such as of the sulfate salts and the chlorides as the metal salts do not react in a heat treatment, the deposited microparticles are washed with a saturated lithium carbonate solution, and thereafter filtered out. In the case where lithium compounds such as of the nitrate salts and the acetate salts react in the heat treatment as a lithium raw material, the deposited microparticles are not washed, and filtered out as they are, and dried to thereby make a firing precursor.

Then, the filtered-out lithium-containing carbonate salts are dried to thereby obtain a powder of a composite material (precursor for a lithium ion battery cathode material) of lithium salts.

Then, a firing vessel having a predetermined volume is prepared; and the powder of the precursor for a lithium ion battery cathode material is filled in the firing vessel. Then, the firing sagger filled with the powder of the precursor for a lithium ion battery cathode material is transferred into a firing oven, and the powder is fired. The firing is carried out by holding the heating for a predetermined time in an oxygen atmosphere. If the firing is carried out under pressure of 101 to 202 kPa, since the amount of oxygen in the composition increases, the firing is preferable.

Thereafter, the powder is taken out from the firing sagger, and crushed by using a commercially available crusher or the like to thereby obtain a powder of a cathode active material. The crushing is preferably carried out so as not to generate as few micro powders as possible by suitably regulating the crushing strength and the crushing time specifically so that micro powder of 4 pm or smaller in particle diameter is 10% or less in terms of volume fraction, or so that the specific surface area of the powder becomes 0.40 to 0.70 m²/g.

By controlling the generation of micro powder in the crushing time in such a manner, since the surface area of the powder per volume decreases, the area of the powder exposed to the air can be suppressed. Therefore, the moisture absorption of the power of the precursor in the storing time and the like can well be suppressed.

In the present invention, the Ni concentration in the powder is high, and when the nascent surface of the powder particles is exposed in the crushing, moisture is immediately adsorbed. Therefore, the dew point control of the powder in the crushing time is important. Specifically, the crushing is carried out under control of the dew point of the crushing atmosphere for the powder at -40 to -60° C., and the dew point of the crushing atmosphere can be controlled by blowing in a dried air whose dew point is controlled at an air volume of 5 to 15 m³/min. The similar control of the dew point in a booth where a sample after crushing is taken out is also effective.

### EXAMPLES

Hereinafter, Examples are provided in order to well understand the present invention and its advantages, but the present invention is not limited to these Examples.

### Examples 1 to 12

First, nitrate salts were prepared so that each metal contained in metal salts was in a molar ratio in Table 1. Then, lithium carbonate was suspended in pure water, and thereafter, the metal salt solution was charged therein.

The microparticulate lithium-containing carbonate salts thus deposited in the solution by this treatment, and the deposits were filtered out using a filter press.

Then, the deposits were dried to thereby obtain a lithium-containing carbonate salt (precursor for a lithium ion battery cathode material).

Then, a firing sagger was prepared, and the lithium-containing carbonate salt was filled in the firing vessel. Then, the firing sagger was put in an oxygen-atmosphere oven in the atmospheric pressure, and heated and held at a firing temperature of 850 to 980° C. for 24 hours, and then cooled to thereby obtain an oxide.

Then, the obtained oxide was crushed under control of the dew point of the crushing atmosphere at -40 to −60° C., to thereby obtain a powder of a cathode material for a lithium ion secondary battery. The dew point of the crushing atmosphere was controlled by blowing in a dried air whose dew point was controlled at an air volume of 6 m³/min.

### Example 13

In Example 13, the same process was carried out as in Examples 1 to 12, except for using a composition shown in Table 1 of each metal contained in the metal salts, using chlorides as the metal salts, and washing the deposit with a saturated lithium carbonate solution and filtering the resultant after a lithium-containing carbonate salt was deposited.

### Example 14

In Example 14, the same process was carried out as in Examples 1 to 12, except for using a composition shown in Table 1 of each metal contained in the metal salts, using sulfate salts as the metal salts, and washing the deposit with a saturated lithium carbonate solution and filtering the resultant after a lithium-containing carbonate salt was deposited.

### Example 15

In Example 15, the same process was carried out as in Examples 1 to 12, except for using a composition shown in Table 1 of each metal contained in the metal salts, and carrying out the firing under pressure of 120 kPa in place of the atmospheric pressure.

### Comparative Examples 1 to 3

In Comparative Examples 1 to 3, the same process was carried out as in Examples 1 to 6, except for using compositions shown in Table 1 of each metal contained in the metal salts, and carrying out no regulation as in Examples 1 to 6 for the control of the dew point in the crushing of the final oxide, that is, blowing in no dried air.

(Evaluations)

—Evaluation of a Cathode Active Material Composition—

The metal content of a cathode material (a composition formula: LiₓNi_{1-y}M_{y}O_{2+α}) was measured by an inductively coupled plasma atomic emission spectrometer (ICP-OES), and the compositional ratio (molar ratio) of each metal was calculated. The oxygen content was measured by a LECO method, and a was calculated. These numerical values were as shown in Table 1.

—Evaluation by TPD-MS Measurement—

About 50 mg of the powder of each cathode material was weighed, and heated from room temperature to 1000° C. at a temperature-rising rate of 10° C/min in a TPD-MS analyzer (heating apparatus: made by TRC, MS analyzer: made by Shimadzu Corp.). Sodium tungstate dihydrate, carbon dioxide, and air were used as reference materials. The maximum value of the generation rate in a peak originated from H₂O in the region of 200 to 400° C., and the maximum value of the generation rate in a peak originated from CO₂ gas in the region of 150 to 400° C. were thereby each determined.

—Evaluation of Battery Properties—

Each cathode material, an electroconductive material, and a binder were weighed in a proportion of 85:8:7; the cathode material and the electroconductive material were mixed with a solution in which the binder was dissolved in an organic solvent (N-Methylpyrrolidone) to thereby make a slurry; and the slurry was applied on an Al foil, dried, and thereafter pressed to thereby make a cathode. Then, a 2032-type coin cell with Li as a counter electrode for evaluation was fabricated; and a discharge capacity at a current density of 0.2 C was measured using an electrolyte solution in which 1M-LiPF₆ was dissolved in EC-DMC (1:1). The charge and discharge efficiency was calculated from the initial discharge capacity and the initial charge capacity acquired by the battery measurement.

These results are shown in Table 1.

TABLE 1

| | | | | | | | | | | | | | | | | | | | Maximum | Maximum |
|---|---|---|---|---|---|---|---|---|---|---|---|---|---|---|---|---|---|---|---|---|
| | | | | | | | | | | | | | | | | | | | Value of | Value of |
| | | | | | | | | | | | | | | | | | | | CO₂ | H₂O |
| | | | | | | | | | | | | | | | | | | Charge | Generation | Generation |
| | | | | | | | | | | | | | | | | | | and | Rate | Rate |
| | | | | | | | | | | | | | | | | | Discharge | Discharge | (ppm by | (ppm by |
| | Molar Ratio | | | | | | | | | | | | | | | | Capacity | Efficiency | weight/ | weight/ |
| | Li | Ni | Mn | Co | Ti | V | Cr | Fe | Cu | Zn | Al | Sn | Mg | Zr | x | α | (mAh/g) | (%) | sec) | sec) |
| Example 1 | 1442 | 33 | 33 | 33.3 | | | | | | | | 1 | | | 1 | 0.05 | 155 | 90 | 0.1 | 0.4 |
| Example 2 | 1993 | 50 | 30 | 20 | | | | | | | | | | | 1 | 0.10 | 160 | 89 | 0.2 | 0.8 |
| Example 3 | 1993 | 60 | 25 | 15 | | | | | | | | | | | 1.025 | 0.07 | 175 | 87 | 3 | 5 |
| Example 4 | 1993 | 70 | 15 | 15 | | | | | | | | | | | 1 | 0.09 | 188 | 88 | 1.1 | 1.4 |
| Example 5 | 1993 | 80 | 10 | 10 | | | | | | | | | | | 1.005 | 0.09 | 195 | 87 | 1.5 | 2.3 |
| Example 6 | 1993 | 80 | 10 | 10 | | | | | | | | | | | 1 | 0.05 | 195 | 90 | 0.6 | 0.9 |
| Example 7 | 1993 | 80 | | 15 | | | | | | | 5 | | | | 1.01 | 0.03 | 195 | 89 | 0.2 | 1.8 |
| Example 8 | 1993 | 80 | | 15 | 2.5 | | | | | | | | 2.5 | | 1.01 | 0.10 | 193 | 88 | 0.5 | 1.6 |
| Example 9 | 1993 | 80 | | 15 | | 2.5 | | | | | | | | 2.5 | 1 | 0.00 | 193 | 88 | 0.5 | 1.5 |
| Example 10 | 1993 | 80 | | 15 | | | 5 | | | | | | | | 1 | 0.04 | 192 | 88 | 0.7 | 2 |
| Example 11 | 1993 | 80 | | 15 | | | | 2.5 | | 2.5 | | | | | 1.02 | 0.09 | 192 | 88 | 0.7 | 2 |
| Example 12 | 1993 | 80 | | 15 | | | | | 5 | | | | | | 1.01 | −0.10 | 190 | 87 | 0.9 | 2.5 |
| Example 13 | 1993 | 50 | 30 | 20 | | | | | | | | | | | 1 | 0.01 | 162 | 89 | 0.2 | 0.5 |
| Example 14 | 1442 | 60 | 25 | 15 | | | | | | | | | | | 1.075 | 0.02 | 176 | 87 | 1.5 | 1.9 |
| Example 15 | 1993 | 80 | 10 | 10 | | | | | | | | | | | 1 | 0.10 | 195 | 88 | 0.5 | 2.8 |
| Comparative | 1993 | 60 | 25 | 15 | | | | | | | | | | | 1 | 0.10 | 165 | 85 | 4 | 6 |
| Example 1 | | | | | | | | | | | | | | | | | | | | |
| Comparative | 1993 | 70 | 10 | 20 | | | | | | | | | | | 1 | 0.08 | 180 | 85 | 5 | 7 |
| Example 2 | | | | | | | | | | | | | | | | | | | | |
| Comparative | 1993 | 80 | 10 | 10 | | | | | | | | | | | 1.005 | 0.00 | 185 | 84 | 8 | 8 |
| Example 3 | | | | | | | | | | | | | | | | | | | | |

In any of Examples 1 to 15, a composition prescribed in the present invention was obtained; in the TPD-MS measurement, the maximum value of the generation rate in a peak originated from H₂O in the region of 200 to 400° C. was 5 ppm by weight/sec or lower, and the maximum value of the generation rate in a peak originated from CO₂ gas in the region of 150 to 400° C. was 3 ppm by weight/sec or lower; and both of the discharge capacity and the charge and discharge efficiency were good.

In Comparative Examples 1 to 3, the maximum value of the generation rate in a peak originated from H₂O in the region of 200 to 400° C. exceeded 5 ppm by weight/sec and the maximum value of the generation rate in a peak originated from CO₂ gas in the region of 150 to 400° C. exceeded 3 ppm by weight/sec in the TPD-MS measurement; and the discharge capacity and/or the charge and discharge efficiency was poor.

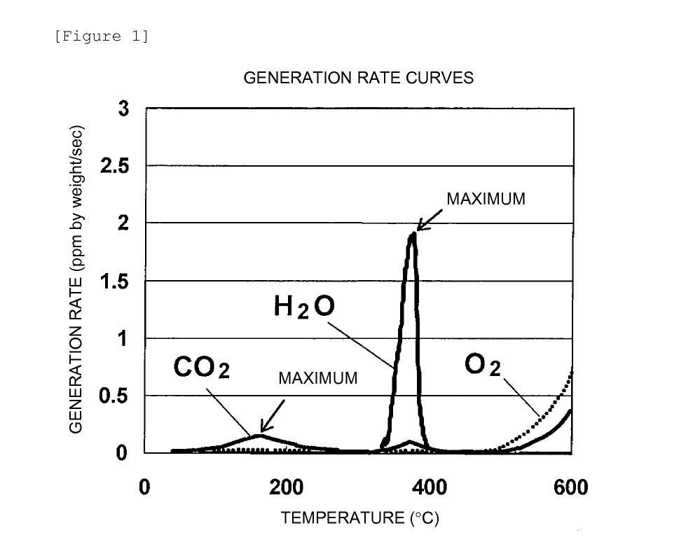

FIG. 1 shows generation rate curves of H₂O, CO₂, and O₂ acquired by the TPD-MS measurement in Example 7. In FIG. 1, a peak originated from H₂O in the region of 200 to 400° C., a peak originated from CO₂ gas in the region of 150 to 400° C., and maximum positions in the peaks are observed. In the present invention, these maximum values of the generation rate curves of H₂O and CO₂ are controlled.

1. (canceled)

2. (canceled)

3. A cathode active material for a lithium ion battery represented by a composition formula:
LiₓNi_{1-y}M_{y}O_{2+α}
wherein 0.9≦x≦1.2; 0<y≦0.7; and −0.1≦α≦0.1; and M is a metal,
wherein a maximum value of the generation rate in a peak originated from H₂O in the region of 200 to 400° C. is 5 ppm by weight/sec or lower, and a maximum value of the generation rate in a peak originated from CO₂ gas in the region of 150 to 400° C. is 3 ppm by weight/sec or lower in a measurement by TPD-MS of 5 to 30 mg of the cathode active material.

4. The cathode active material for a lithium ion battery according to claim 3, wherein the maximum value of the generation rate in the peak originated from H₂O in the region of 200 to 400° C. is 3 ppm by weight/sec or lower in the measurement by TPD-MS of 5 to 30 mg of the cathode active material.

5. The cathode active material for a lithium ion battery according to claim 3, wherein the maximum value of the generation rate in the peak originated from CO₂ gas in the region of 150 to 400° C. is 2 ppm by weight/sec or lower in the measurement by TPD-MS of 5 to 30 mg of the cathode active material.

6. The cathode active material for a lithium ion battery according to claim 3, wherein the M is one or more selected from Ti, V, Cr, Mn, Co, Fe, Mg, Cu, Zn, Al, Sn, and Zr.

7. The cathode active material for a lithium ion battery according to claim 6, wherein the M is one or more selected from Mn and Co.

8. A cathode for a lithium ion battery, using a cathode active material for a lithium ion battery according to claim 3.

9. A lithium ion battery, using a cathode for a lithium ion battery according to claim 8.
